(19) United States
(12) Patent Application Publication
(10) Pub. No.: US 2008/0104602 A1
(43) Pub. Date: May 1, 2008

(54) TASK SWITCHING CONTROL METHOD AND COMPUTER SYSTEM

(75) Inventor: Akira TAKEUCHI, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/868,089

(22) Filed: Oct. 5, 2007

(30) Foreign Application Priority Data
Oct. 25, 2006 (JP) 2006-290466

(51) Int. Cl. G06F 9/50; G06F 9/46

(52) U.S. Cl. 718/103; 718/104

(57) ABSTRACT

The task switching control method of the present invention is a task switching control method in a computer system in which plural tasks run, and includes a detection step of detecting a wakeup request of a task, a first resource obtainment step of obtaining first resource data which is data of computer resources being used among computer resources of the computer system, a second resource obtainment step of obtaining second resource data which is data of computer resources which are necessary to execute the task of which the wakeup request is detected, a judgment step of judging whether or not the task can be switched to the task of which the wakeup request is detected, based on the obtained first resource data and the obtained second resource data, and a switching step of switching the task to the task of which the wakeup request is detected when it is judged in the judgment step that the task switching can be executed.

### BACKGROUND OF THE INVENTION

(1) Field of the Invention

The present invention relates to a task switching control method and a computer system, and more particularly, to a task switching control method in a computer system in which plural tasks run.

(2) Description of the Related Art

With the increase in the performance of hardware and in the scale of software, the transition to more highly-functional general-purpose OS (Operating System) is progressing even in the embedded market in which simple and light real-time OS is conventionally used. API (Application Program Interface) of the real-time OS is generally different from that of the general-purpose OS, so that it is not possible to make software built on the real-time OS to run directly on the general-purpose OS. Moreover, even in case that the replacement of the API is executed, the general-purpose OS has a relatively low real-time performance. Thus, when real-time operation is required of the object system, there is a high possibility that a design modification of asset software is necessary. As a result, high development cost is necessary for the transition of the real-time OS to the general-purpose OS.

Consequently, a hybrid OS which combines the real-time OS with the general-purpose OS is designed. The hybrid OS enables a large and high-value added system to be developed with low development costs, by diverting the asset software and using the function of the general-purpose OS.

Two main types of the hybrid OS are a hybrid OS which operates a general-purpose OS and a real-time OS on different CPUs, respectively, and a hybrid OS in which the OS (guest OS) runs as at least one task on the other OS (host OS) which runs on at least one CPU. In the latter hybrid OS, for example, the general-purpose OS runs as the host OS and the real-time OS runs as the guest OS.

In the former hybrid OS, the level of coupling between the general-purpose OS and the real-time OS is low and hardware resources including the CPU or the like are independently assigned to the general-purpose OS and the real-time OS, so that the OS and the application software can be operated directly. Consequently, the former hybrid OS can easily guarantee the real-timeliness of the system. However, the former hybrid OS also has the disadvantage that the cost of the hardware increases.

The latter hybrid OS needs at least an alteration of the guest OS, however, it is basically possible to operate the application software without change. In the latter hybrid OS, the host OS and the guest OS run together while exclusively controlling the hardware resources, so that the cost of the hardware can be reduced. However, in the latter hybrid OS, each of the host OS and the guest OS cannot occupy the hardware resources such as the CPU or the like, so that ingenuity becomes necessary in the building of a real-time processing system.

In the hybrid OS in which the guest OS runs as at least one task on the host OS, a scheduler is used for a switching process between the host OS and the guest OS, so that an interrupt performance and a task switching performance of the guest OS generally depend on a performance of the host OS. In particular, in case that a request to wakeup the guest OS task occurs due to an interrupt when the host OS is running, the task switching to the guest OS task is executable only when the scheduler of the host OS is executable. For example, when the host OS cannot execute a kernel preemption and when it receives a wakeup request to a high priority task by the interrupt during the kernel processing, the task switching to the high priority task is not executable until the current kernel processing is completed. Consequently, the task switching to the high priority task is delayed. Even when the host OS permits the kernel preemption, there is a preemption-prohibited section to control exclusively the various resources. The task switching to the high priority task is thereby delayed in the preemption-prohibited section. Consequently, a micro-kernel which only has minimally functions including a scheduling, an interrupt control, and so on, so that the deterioration in the interrupt performance and the task switching performance of the guest OS is prevented (micro-kernel system) and a real-time OS which has the excellent interrupt performance and the task switching performance (hybrid system) are often used as the host OS.

As described above, in the hybrid OS in which the general-purpose OS is used for the host OS, the interrupt performance and the task switching performance depend on the performance of the general-purpose OS. Consequently, the hybrid OS in which the general-purpose OS is used for the host OS has been used for a system which does not need an accurate real-time operation or a simulator used for a logic debug.

In contrast, with regard to the hybrid OS in which the real-time OS runs on the general-purpose OS, there is a known method which achieves the interrupt performance which is not influenced by the general-purpose OS (for example, refer to Japanese Laid-Open Patent Publication 2006-146758). As an advantage of building the real-time OS on the general-purpose OS, for example, a high memory protection mechanism of the general-purpose OS can be used in the real-time OS.

Hereinafter, a task switching control in the conventional hybrid OS in which the real-time OS runs on the general-purpose OS is described.

FIG. 1 is a flow chart showing a task switching process in the conventional hybrid OS in which the real-time OS runs on the general-purpose OS.

As shown in FIG. 1, firstly, a wakeup request of the task is detected (S1001). When the wakeup request is detected (Yes in S1001), it is judged whether the task switching is executable or not (S1002). For example, whether or not the switching on the OS is executable is stipulated depending on the resources being used and, when the switching is executable, it is judged that the task switching is executable. In particular, plural resources are specified to stably execute the switching to all the particular tasks (for example, the tasks of the real-time OS running on the general-purpose OS), and when all the specified resources are not in use, it is judged that the task switching is executable. During the execution the interrupt process, it is judged that the switching is not executable. When it is judged that the task switching is executable (Yes in S1002), the task switching is executed (S1003). When it is judged that the task switching is not executable (No in S1002), the task switching is not executed.

The task switching process in the hybrid OS in which the real-time OS runs on the general-purpose OS is described with using FIG. 1, however, the process in FIG. 1 is also applied to the switching process on the specified task of high priority on the single OS.

### SUMMARY OF THE INVENTION

However, a higher task response performance is required for the task switching process. In the above conventional task switching method, the task switching to the specified task is executed when all the resources which enable a computer system (OS) to stably execute the switching are not in use. Thus, when some of the resources which enable the computer system (OS) to stably execute the switching are in use, the task switching is not executed, and the task response performance is not sufficient.

Consequently, an object of the present invention is to provide a task switching control method and a computer system which have a high task response performance.

In order to achieve the aforementioned object, the task switching control method according to the present invention is a task switching control method in a computer system in which plural tasks run, the method includes: a detection step of detecting a wakeup request of a task; a first resource obtainment step of obtaining first resource data which is data of computer resources being used, among computer resources of the computer system; a second resource obtainment step of obtaining second resource data which is data of computer resources which are necessary to execute the task of which the wakeup request is detected in the detection step; a first judgment step of judging whether or not the task can be switched to the task of which the wakeup request is detected in the detection step, based on the first resource data obtained in the first resource obtainment step and the second resource data obtained in the second resource obtainment step; and a first switching step of switching the task to the task of which the wakeup request is detected in the detection step when it is judged in the first judgment step that the task switching can be executed.

According to this configuration, it is judged whether the task switching is executable or not based on the data of the computer resources being used and the computer resources which are necessary to execute the task of which the wakeup request is detected. Thus, when the computer resources which are minimally necessary to execute the task are not in use, the task switching is executable. Consequently, the task switching is executable in many circumstances compared to the conventional computer system which executes the task switching only when all the resources which enable the computer system to stably execute the switching are not in use. Thus, the present invention can achieve the task switching control method which has the high task response performance.

Furthermore, it is also possible that the computer system executes the plural tasks under control of an OS (Operating System), the plural tasks include: a normal task which runs on the OS and uses all of the computer resources of the OS; and a limited task which runs on the OS and uses only part of the computer resources of the OS, in the detection step, a wakeup request of the limited task is detected, in the first resource obtainment step, the first resource data is obtained, the first resource data being the data of the computer resources being used, among the computer resources of the OS, in the second resource obtainment step, the second resource data is obtained, the second resource data being the data of the computer resources of OS which are necessary to execute the limited task of which the wakeup request is detected in the detection step, in the first judgment step, it is judged whether or not the task can be switched to the limited task of which the wakeup request is detected in the detection step, based on the first resource data obtained in the first resource obtainment step and the second resource data obtained in the second resource obtainment step, and in the first switching step, the task is switched to the limited task of which the wakeup request is detected in the detection step when it is judged in the first judgment step that the task switching can be executed.

According to this configuration, it is judged whether the task switching is executable or not based on the data of the computer resources of the OS being used and the computer resources of the OS which are necessary to execute the limited task of which the wakeup request is detected. Thus, when the computer resources of the OS which are minimally necessary to execute the limited task are not in use, the task switching is executable. Consequently, the task switching is executable in many circumstances compared to the conventional computer system which executes the task switching only when all the resources which enable the computer system to stably execute the switching are not in use. Thus, the present invention can achieve the task switching control method which has the high task response performance.

Furthermore, it is also possible that the computer system executes the plural tasks under control of a first OS and a second OS which runs as at least one task on the first OS, the plural tasks include: a host OS task which runs on the first OS; and a guest OS task on the second OS, which runs as the task on the first OS and uses the first OS as a host OS, in the detection step, a wakeup request of the guest OS task is detected, in the first resource obtainment step, the first resource data is obtained, the first resource data being the data of the computer resources being used, among the computer resources of the first OS, in the second resource obtainment step, the second resource data is obtained, the second resource data being the data of the computer resources of the first OS which are necessary to execute the guest OS task of which the wakeup request is detected in the detection step, in the first judgment step, it is judged whether or not the task can be switched to the guest OS task of which the wakeup request is detected in the detection step, based on the first resource data obtained in the first resource obtainment step and the second resource data obtained in the second resource obtainment step, and in the first switching step, the task is switched to the guest OS task of which the wakeup request is detected in the detection step when it is judged in the first judgment step that the task switching can be executed.

According to this configuration, it is judged whether the task switching is executable or not based on the data of the computer resources of the first OS being used and the computer resources of the first OS which are necessary to execute the guest OS task of which the wakeup request is detected. Thus, when the computer resources of the first OS which are minimally necessary to execute the guest OS task are not in use, the task switching is executable. Consequently, the task switching is executable in many circumstances compared to the conventional computer system which executes the task switching only when all the resources which enable the computer system to stably execute the switching are not in use. Accordingly, it is possible to minimize the dependence on the task response time of the host OS and to build the guest OS having high task response on the host OS having low task response. Thus, the present invention can achieve the task switching control method which has the high task response performance.

Furthermore, it is also possible that in the first judgment step, when all of the computer resources to be used by the guest OS task of which the wakeup request is detected in the detection step are not in use, it is judged that the task can be switched to the guest OS task.

According to this configuration, when the computer resources of the first OS which are minimally necessary to execute the guest OS task are not in use, the task switching is executed. Consequently, the task response can be improved.

Furthermore, it is also possible that the task switching control method further includes: a first detection step of detecting that the computer resources of the first OS being used are released when it is judged in the first judgment step that the task cannot be switched to the guest OS task of which the wakeup request is detected; a first resource reobtainment step of obtaining again the first resource data which is the data of the computer resources of the first OS being used, among the computer resources of the first OS, when it is detected in the first detection step that the computer resources of the first OS being used are released; and a rejudgment step of judging whether or not the task can be switched to the guest OS task of which the wakeup request is detected in the detection step, based on the first resource data obtained in the first resource reobtainment step and the second resource data obtained in the second resource obtainment step.

According to this configuration, when the computer resources of the first OS which are necessary to execute the guest OS task are in use and when the task switching is not executable, the status of use regarding the computer resources of the first OS is monitored, and upon the release of the computer resources of the first OS which are necessary to execute the guest OS task, the task switching is executable. Thus, the task response can be improved when the computer resources which are necessary to execute the guest OS task are in use and when the task switching is not executable.

Furthermore, it is also possible that the task switching control method further includes: a third resource obtainment step of obtaining third resource data which is data of the computer resources of the first OS which are necessary to execute an interrupt process; a second judgment step of judging whether or not at least part of the computer resources which are necessary to execute the interrupt process are in use, based on the first resource data obtained in the first resource obtainment step and the third resource data obtained in the third resource obtainment step; and an interrupt prohibition step of prohibiting the interrupt process when it is judged in the second judgment step that at least part of the computer resources which are necessary to execute the interrupt process is in use.

According to this configuration, when the computer resources of the first OS which are necessary to execute the interrupt process are in use, the interrupt is prohibited during the execution of the guest OS task. Consequently, the error caused by the interrupt and so on can be prevented in case that the interrupt occurs during the execution of the guest OS task.

Furthermore, it is also possible that the task switching control method further includes: a third resource obtainment step of obtaining third resource data which is data of the computer resources of the first OS which are necessary to execute an interrupt process; a second judgment step of judging whether or not at least part of the computer resources which are necessary to execute the interrupt process is in use, based on the first resource data obtained in the first resource obtainment step and the third resource data obtained in the third resource obtainment step; a second detection step of detecting that the computer resources being used are released when it is judged in the second judgment step that at least part of the computer resources which are necessary to execute the interrupt process are in use; and a second rejudgment step of judging again whether or not at least part of the computer resources of the first OS which are necessary to execute the interrupt process is in use when it is detected in the second detection step that the computer resources of the first OS being used are released, and in the first switching step, the task is switched to the guest OS task of which the wakeup request is detected in the detection step when it is judged in the first judgment step that the task switching can be executed and it is judged in the second rejudgment step that at least part of the computer resources of the first OS which are necessary to execute the interrupt process is not in use.

According to this configuration, when the computer resources of the first OS which are necessary to execute the interrupt process are in use and when the interrupt process is not executable during the execution of the guest OS task, the status of use regarding the computer resources of the first OS is monitored, and upon the release of the computer resources of the first OS which are necessary to execute the interrupt process, the task switching is executable. Thus, the task response can be improved when the computer resources which are necessary to execute the interrupt process are in use and when the task switching is not executable. Moreover, the error caused by the interrupt and so on can be prevented in case that the interrupt occurs during the execution of the guest OS task.

Furthermore, it is also possible that the task switching control method further includes: an environment retention step of retaining an environment of the first OS when it is judged in the first judgment step that the task can be switched to the guest OS task of which the wakeup request is detected in the detection step; and an environment return step of causing the environment retained by the environment retention step return when the guest OS task is completed.

According to this configuration, in case of switching to the guest OS task during the execution of the host OS task and making the host OS task return after completing the guest OS task, the environment of the OS before being switched to the guest OS task can be returned. Consequently, the consistency of the OS environment before and after executing the guest OS task can be ensured.

Furthermore, it is also possible that the task switching control method further includes: a change request obtainment step of obtaining a request to change a state of the host OS task which is executed before switching the task in the first switching step, during execution of the guest OS task that is switched to in the first switching step; and a task state change step of changing the environment retained in the environment retention step based on the change request obtained in the change request obtainment step, wherein in the environment return step, the environment which is changed in the task state change step is returned.

According to this configuration, when the change request to change the state of the host OS task which is executed before the task switching (the priority and the run state) occurs, the environment of the OS which is retained in the environment retention step is changed. Consequently, the state of the host OS task after returning can be changed and the consistency of the computer system can be maintained.

Furthermore, it is also possible that the task switching control method further includes: a second switching step of switching the task to a host OS task which is executed last among the host OS tasks, after the guest OS task which is switched to in the first switching step is completed.

According to this configuration, the host OS task which is executed before being switched to the guest OS task can be returned after completing the guest OS task. Consequently, the host OS task which is executed before being switched to the guest OS task is executable continuously after completing the guest OS task.

Furthermore, it is also possible that the task switching control method further includes: a task judgment step of judging whether or not at least one of the plural guest OS tasks is executable; and a second switching step of switching the task to the host OS task which is executed last among the host OS tasks, after the guest OS task is completed when it is judged in the task judgment step that at least one of the plural guest OS tasks is not executable.

According to this configuration, the host OS task which is executed before being switched to the guest OS task can be returned after executing all the executable guest OS tasks. Consequently, the host OS task which is executed before being switched to the guest OS task is executable continuously after completing all the executable guest OS tasks.

Furthermore, it is also possible that the host OS task and the guest OS task each have a priority for determining a task execution sequence, and the task switching control method further includes: a priority change step of changing a priority of the host OS task which is executed before switching the task in the first switching step to a highest priority among the host OS tasks, when it is judged that the task can be switched to the task on the guest OS task.

According to this configuration, the host OS task which is executed before being switched to the guest OS task can be returned after executing all the executable guest OS tasks by making the priority of the host OS task which is executed before being switched to the guest OS task highest in the priority of the host OS task. Consequently, the host OS task which is executed before being switched to the guest OS task is executable continuously after completing all the executable guest OS tasks. Furthermore, it is possible to automatically execute the host OS task which is executed before executing the task switching without improving the function of the existing OS (for example, improving the scheduler).

Furthermore, it is also possible that the plural tasks include a plurality of the guest OS tasks, the task switching control method further includes a third judgment step of judging whether or not the first OS is ready for switching the task to all of the host OS task and the plurality of guest OS tasks, in the first switching step, the task is switched to a guest OS task of which the wakeup request is detected in the detection step, when it is judged in the third judgment step that the first OS is ready for the switching, and in the first judgment step, it is judged whether or not the task can be switched to the guest OS task of which the wakeup request is detected in the detection step, based on the first resource data obtained in the first resource obtainment step and the second resource data obtained in the second resource obtainment step, when it is judged in the third judgment step that the first OS is not ready for the switching.

According to this configuration, when the first OS is ready for the task switching, the first OS execute the task switching without executing the first resource obtainment step, the second resource obtainment step, and the first judgment step. Consequently, the amount of processing of the first OS which is ready for the task switching can be reduced.

Furthermore, the computer system according to the present invention is a computer system in which plural tasks run, including: a detection unit which detects a wakeup request of a task; a first resource obtainment unit which obtains first resource data which is data of computer resources being used among computer resources of the computer system; a second resource obtainment unit which obtains second resource data which is data of computer resources which are necessary to execute the task of which the wakeup request is detected by the detection unit; a first judgment unit which judges whether or not the task can be switched to the task of which the wakeup request is detected by the detection unit, based on the first resource data obtained by the first resource obtainment unit and the second resource data obtained by the second resource obtainment unit; and a switching unit which switches the task to the task of which the wakeup request is detected by the detection unit when the first judgment unit judges that the task switching is executable.

According to this configuration, it is judged whether the task switching is executable or not based on the data of the computer resources being used and the computer resources which are necessary to execute the task of which the wakeup request is detected. Thus, when the computer resources which are minimally necessary to execute the task are not in use, the task switching is executable. Consequently, the task switching is executable in many circumstances compared to the conventional computer system which executes the task switching only when all the resources which enable the computer system to stably execute the switching are not in use. Thus, the present invention can achieve a computer system which has a high task response performance.

The present invention can be implemented not only as the task switching control method described above but also as a computer system having, as units, the characteristic steps included in the task switching control method, and as a program which controls a computer to execute the characteristic steps included in the task switching control method. Needless to say such a program can be distributed through a recording medium such as a CD-ROM or a transmission medium such as the Internet.

The present invention can provide a task switching control method and a computer system which have a high task response performance.

### Further Information about Technical Background to this Application

The disclosure of Japanese Patent Application No. 2006-290466 filed on Oct. 25, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a flow chart showing a task switching process in a conventional computer system;

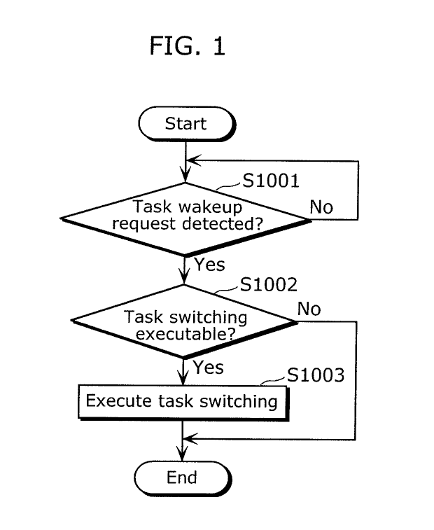

FIG. 2 is a diagram showing a configuration of a computer system according to the first embodiment of the present invention;

FIG. 3 is a flow chart showing a task switching process in the computer system according to the first embodiment of the present invention;

FIG. 4 is a diagram showing a configuration of a computer system according to the second embodiment of the present invention;

FIG. 5 is a flow chart showing a task switching process in the computer system according to the second embodiment of the present invention;

FIG. 6 is a diagram showing a configuration of a computer system according to the third embodiment of the present invention;

FIG. 7 is a flow chart showing a task switching process in the computer system according to the third embodiment of the present invention;

FIG. 8 is a diagram showing a configuration of a task priority in the computer system according to the third embodiment of the present invention;

FIG. 9 is a drawing showing an example of changing the task priority in the computer system according to the third embodiment of the present invention;

FIG. 10 is a flow chart showing a process to change a state of a host OS task during the execution of a privileged guest OS task in the computer system according to the third embodiment of the present invention;

FIG. 11 is a flow chart showing a variation of the task switching process in the computer system according to the third embodiment of the present invention;

FIG. 12 is a drawing showing a configuration of the variation of the computer system according to the third embodiment of the present invention; and

FIG. 13 is a flow chart showing the variation of the task switching process in the computer system according to the third embodiment of the present invention.

### DESCRIPTION OF THE PREFERRED EMBODIMENT(S)

The embodiments of the computer system which uses the task switching control method according to the present invention are described below with reference to the drawings.

### First Embodiment

The computer system according to the first embodiment of the present invention judges whether a task switching is executable or not based on data of computer resources being used and computer resources which are necessary to execute a task of which a wakeup request is detected. Consequently, the computer system which has a high task response performance can be achieved.

First, the configuration of the computer system according to the first embodiment of the present invention is described.

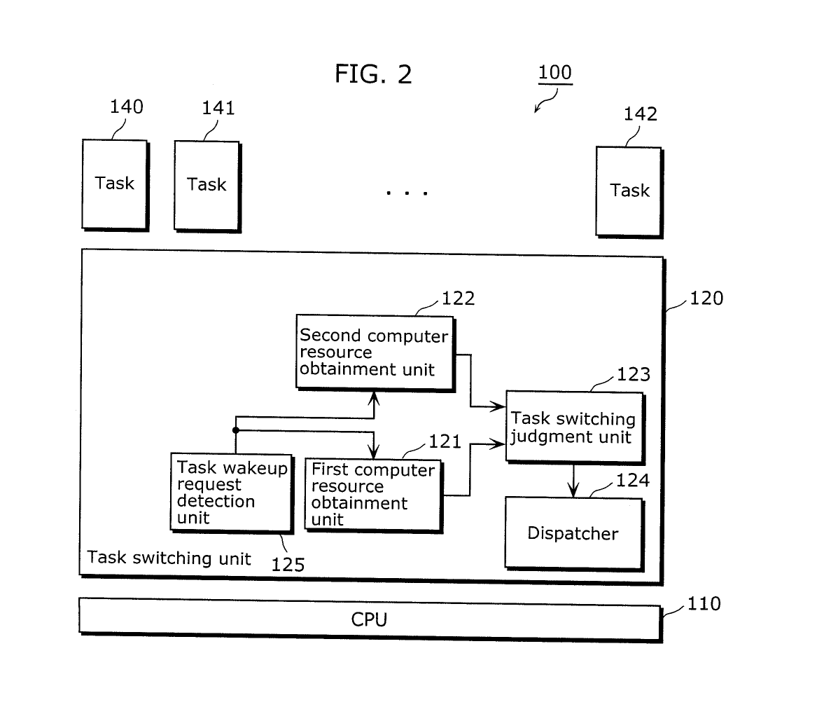

FIG. 2 is a diagram showing the configuration of the computer system according to the first embodiment of the present invention. Plural tasks 140, 141, and 142 run in a computer system 100 shown in FIG. 2. The computer system 100 includes a CPU 110 which is a hardware resource and a task switching unit 120 which is a software resource running on the CPU 110. At this time, the task indicates a run unit of a process on the CPU. Moreover, in an OS which has a virtual memory management function, the plural tasks can share an address space, and a group of these tasks is referred to as a task group.

The task switching unit 120 executes the switching among the plural tasks 140, 141, and 142. The task switching unit 120 includes a first computer resource obtainment unit 121, a second computer resource obtainment unit 122, a task switching judgment unit 123, a dispatcher 124, and a task wakeup request detection unit 125.

The task wakeup request detection unit 125 detects wake-up requests of the tasks 140, 141, and 142.

The first computer resource obtainment unit 121 obtains data of the computer resources being used in the computer resources in the computer system 100. The second computer resource obtainment unit 122 obtains data of the computer resources which are necessary to execute the task of which the wakeup request is detected by the task wakeup request detection unit 125. At this time, the computer resource indicates a memory management structure, a run queue, or the like.

The task switching judgment unit 123 judges whether the task switching to the task of which the wakeup request is detected is executable or not based on the data of the computer resources being used which are obtained by the first computer resource obtainment unit 121 and the data of the computer resources obtained by the second computer resource obtainment unit 122 which are necessary to execute the task of which the wakeup request is detected.

The dispatcher 124 executes the task switching to the task of which the wakeup request is detected by the task wakeup request detection unit 125 when the task switching judgment unit 123 judges that the task switching is executable.

Next, an operation of the computer system 100 is described.

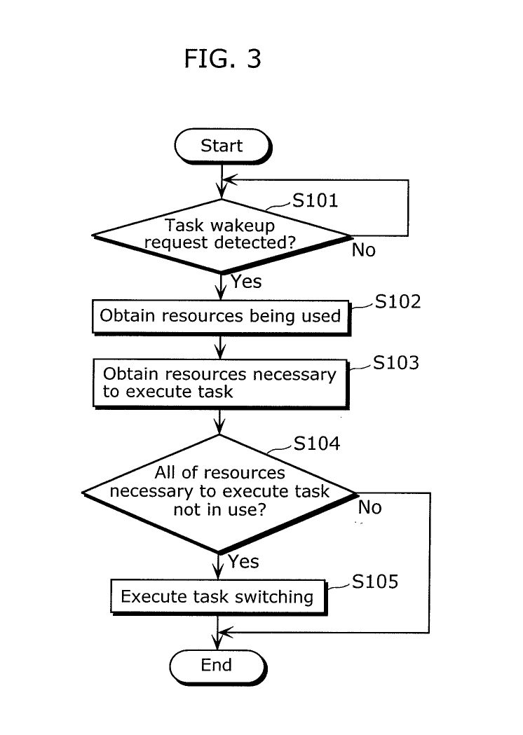

FIG. 3 is a flow chart showing a task switching process in the computer system 100.

As shown in FIG. 3, first, the task wakeup request detection unit 125 detects a wakeup request of the task (S101). An example when the wakeup request of the task 140 is detected is described below. When the task wakeup request detection unit 125 detects the wakeup request of the task 140 (Yes in S101), the first computer resource obtainment unit 121 obtains the data of the computer resources which are currently used by the computer system 100 (S102). Next, the second computer resource obtainment unit 122 obtains the data of the computer resources which are necessary to execute the task 140 (S103).

Next, the task switching judgment unit 123 judges whether the task switching to the task 140 of which the wakeup request is detected is executable or not based on the data of the computer resources being used which are obtained by the first computer resource obtainment unit 121 and the data of the computer resources obtained by the second computer resource obtainment unit 122 which are necessary to execute the task 140 (S104). The task switching judgment unit 123 judges that the task switching to the task 140 of which the wakeup request is detected is executable when all the computer resources which are necessary to execute the task 140 of which the wakeup request is detected are not in use (Yes in S104). The task switching judgment unit 123 judges that the task switching is not executable when at least one of the computer resources which are necessary to execute the task 140 of which the wakeup request is detected is in use (No in S104). When judging that the task switching is executable (Yes in S104), the dispatcher 124 switches the task to the task 140 of which the wakeup request is detected in step S101 (S105). In contrast, when the task switching judgment unit 123 judges that the task switching is not executable (No in S104), the dispatcher 124 does not execute the task switching.

As described above, the computer system 100 according to the first embodiment of the present invention judges whether the task switching is executable or not based on the data of the computer resources being used and the computer resources which are necessary to execute the task of which the wakeup request is detected. Thus, when the computer resources which are minimally necessary to execute the task are not in use, the task switching is executable. Consequently, the task switching is executable in many circumstances compared to the conventional computer system which executes the task switching only when all the resources which enable the computer system to stably execute the switching are not in use. Thus, the computer system 100 according to the first embodiment of the present invention can achieve the computer system which has the high task response performance.

In the above description, the resources which are necessary to execute the task are obtained (S103) after obtaining the resources being used (S102), however, it is also applicable to obtain the resources being used (S102) after obtaining the resources which are necessary to execute the task (S103). Moreover, all or part of the process included in the step to obtain the resources being used (S102) and the step to obtain the resources which are necessary to execute the task (S103) may be executed simultaneously.

### Second Embodiment

The second embodiment of the present invention describes a practical example of applying the present invention to a task switching of a limited task which runs on a single OS.

First, a configuration of the computer system according to the second embodiment of the present invention is described.

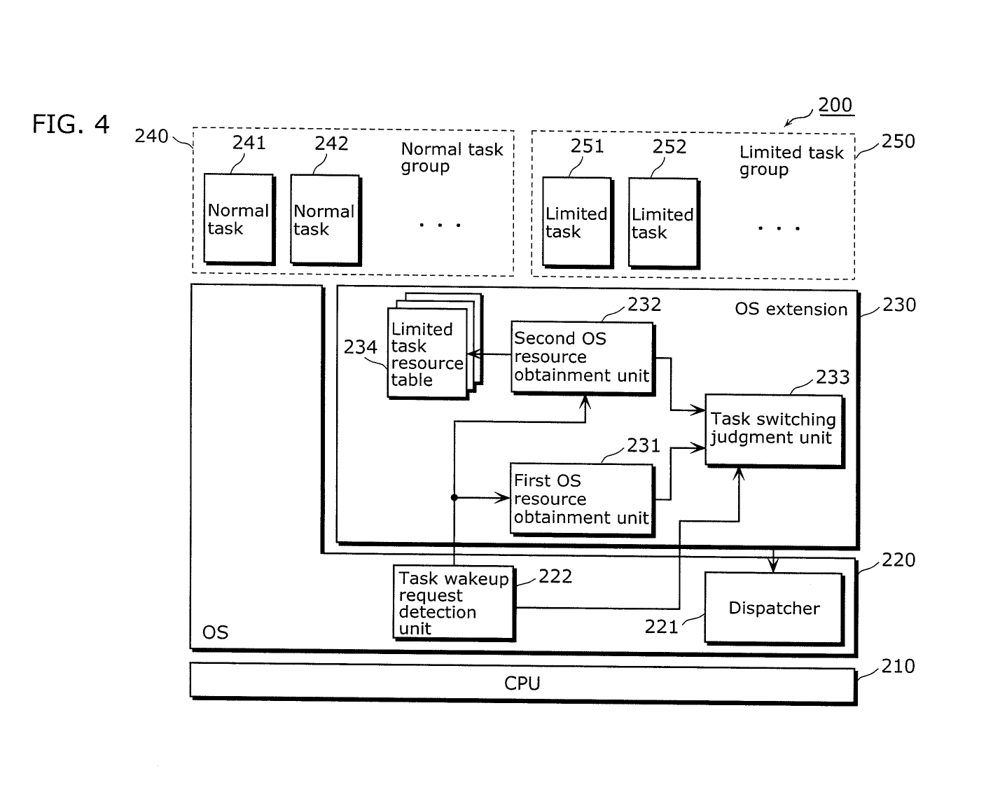

FIG. 4 is a diagram showing the configuration of the computer system according to the second embodiment of the present invention.

A normal task group 240 and a limited task group 250 run in a computer system 200 shown in FIG. 4. The computer system 200 includes a CPU 210 which is a hardware resource and an OS 220 and an OS extension 230 which are software resources running on the CPU 210. The computer system 200 executes the plural tasks included in the normal task group 240 and the limited task group 250 under control of the OS 220.

The normal task group 240 includes plural normal tasks 241 and 242. The limited task group 250 includes plural limited tasks 251 and 252. The normal tasks 241 and 242 run on the OS 220 and use all the computer resources of the OS 220 (abbreviated as the OS resources hereinafter). The limited tasks 251 and 252 run on the OS 220 and use only part of the resources of the OS 220.

The OS 220 includes a dispatcher 221 and a task wakeup request detection unit 222. The OS extension 230 includes a first OS resource obtainment unit 231, a second resource obtainment unit 232, a task switching judgment unit 233 and plural limited task resource tables 234.

The plural limited task resource tables 234 have one-on-one correspondence with the plural limited tasks 251 and 252. The respective limited task resource tables 234 have data of the OS resources which are necessary to execute the corresponding limited tasks 251 and 252.

The task wakeup request detection unit 222 detects wakeup requests of the limited tasks 251 and 252.

The first OS resource obtainment unit 231 obtains the data of the OS resources being used in the computer resources of the OS 220. The second OS resource obtainment unit 232 obtains the data of the OS resources which are necessary to execute the limited task of which the wakeup request is detected with reference to the limited task resource tables 234 corresponding to the limited task of which the wakeup request is detected by the task wakeup request detection unit 222. At this time, the OS resource indicates a memory management structure, a run queue, or the like.

The task switching judgment unit 233 judges whether the task switching to the limited task of which the wakeup request is detected is executable or not based on the data of the OS resources being used which are obtained by the first OS resource obtainment unit 231 and the data of the OS resources obtained by the second OS resource obtainment unit 232 which are necessary to execute the limited task of which the wakeup request is detected.

The dispatcher 221 executes the task switching to the limited task of which the wakeup request is detected by the task wakeup request detection unit 222 when the task switching judgment unit 233 judges that the task switching is executable.

Next, an operation of the computer system 200 is described.

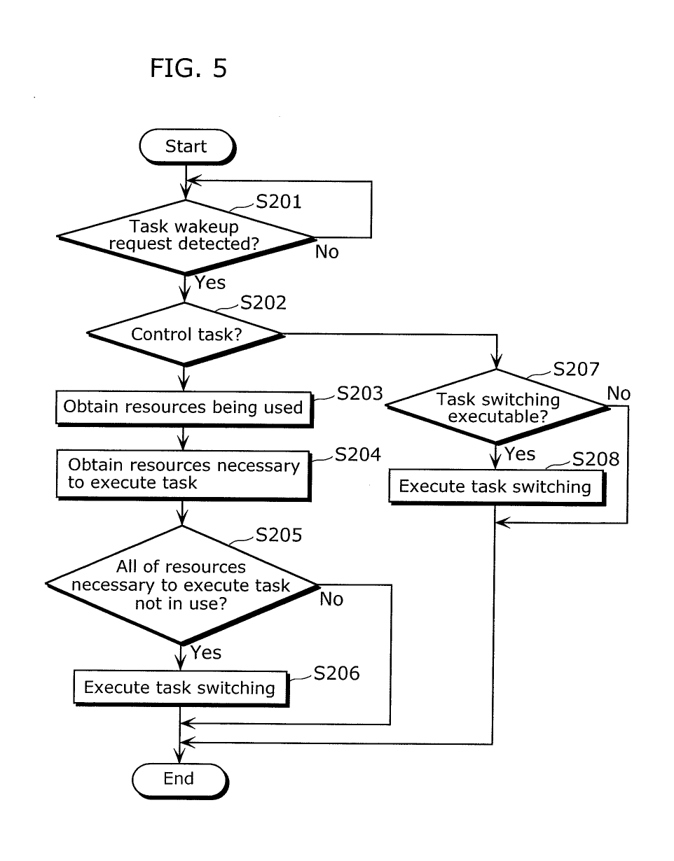

FIG. 5 is a flow chart showing the task switching process in the computer system 200.

As shown in FIG. 5, first, the task wakeup request detection unit 222 detects a wakeup request of the limited task (S201). An example when the wakeup request of the limited task 251 is detected is described below. When the task wakeup request detection unit 222 detects the wakeup request of the limited task 251 (Yes in S201), the task wakeup request detection unit 222 judges whether the detected task is the limited task or not (S202). The detected task is the limited task (Yes in S202), so that the first OS resource obtainment unit 231 next obtains the data of the OS resources which are currently used by the OS 220 (S203). Next, the second OS resource obtainment unit 232 obtains the data of the OS resources which are necessary to execute the limited task 251 with reference to the limited task resource table 234 corresponding to the limited task 251 (S204).

Next, the task switching judgment unit 233 judges whether the task switching to the limited task 251 of which the wakeup request is detected is executable or not based on the data of the OS resources being used which are obtained by the first OS resource obtainment unit 231 and the data of the OS resources obtained by the second OS resource obtainment unit 232 which are necessary to execute the limited task 251 (S205). The task switching judgment unit 233 judges that the task switching to the limited task 251 of which the wakeup request is detected is executable when all the OS resources which are necessary to execute the limited task 251 of which the wakeup request is detected are not in use (Yes in S205). The task switching judgment unit 233 judges that the task switching is not executable when at least one of the OS resources which are necessary to execute the limited task 251 of which the wakeup request is detected is in use (No in S205). When judging that the task switching is executable (Yes in S205), the dispatcher 221 switches the task to the limited task 251 of which the wakeup request is detected in step S201 (S206). In contrast, when the task switching judgment unit 233 judges that the task switching is not executable (No in S205), the dispatcher 221 does not execute the task switching.

Next, an example when the wakeup request of the normal task 241 is detected is described.

When the task wakeup request detection unit 222 detects the wakeup request of the limited task 241 (Yes in S201), the detected task is the normal task (No in S202), so that the task switching judgment unit 233 next judges whether the task switching to the normal task 241 is executable or not (S207). For example, whether or not the switching on the OS is executable is stipulated depending on the resources being used and, when the switching is executable, the task switching judgment unit 233 judges that the task switching is executable. In particular, the plural resources are specified to stably execute the switching to all the tasks, and when all the specified resources are not in use, it is judged that the task switching is executable. During the execution of the interrupt process, it is judged that the switching is not executable.

When the task switching judgment unit 233 judges that the task switching is executable (Yes in S207), the task is switched to the normal task 241 (S208). When the task switching judgment unit 233 judges that the task switching is not executable (No in S207), the task switching is not executed.

As described above, the computer system 200 according to the second embodiment of the present invention judges whether the task switching to the limited task is executable or not based on the data of the OS resources being used and the OS resources which are necessary to execute the limited task of which the wakeup request is detected. Thus, when the OS resources which are minimally necessary to execute the limited task are not in use, the task switching is executable. Consequently, the task switching is executable in many circumstances compared to the conventional computer system which executes the task switching only when all the resources which enable the computer system to stably execute the switching are not in use. Thus, the computer system 200 according to the second embodiment of the present invention can achieve the computer system which has the high task response performance.

In the above description, the resources which are necessary to execute the task are obtained (S204) after obtaining the resources being used (S203), however, it is also applicable to obtain the resources being used (S203) after obtaining the resources which are necessary to execute the task (S204). Moreover, all or part of the process included in step to obtain the resources being used (S203) and in step to obtain the resources which are necessary to execute the task (S204) may be executed simultaneously.

Moreover, when the task of which the wakeup request is detected is the limited task (Yes in S202), the judgment of the switching similar to the step S207 is executable. In this case, when it is judged that the switching is executable, the task switching (S206) must only be executed without executing the processes in step S203, S204, and S205, and when it is judged that the switching is not executable, the processes that follow the step S203 must only be executed. Consequently, when it is judged that the switching is executable by the judgment similar to the step S207, the amount of processing of the first OS can be reduced. Furthermore, the judgment similar to the step S207 is executable before the judgment whether the detected task is the limited task or not (S202).

### Third Embodiment

The third embodiment of the present invention describes a practical example of applying the present invention to a task switching of a guest OS task which runs on a host OS.

First, the computer system according to the third embodiment of the present invention is described.

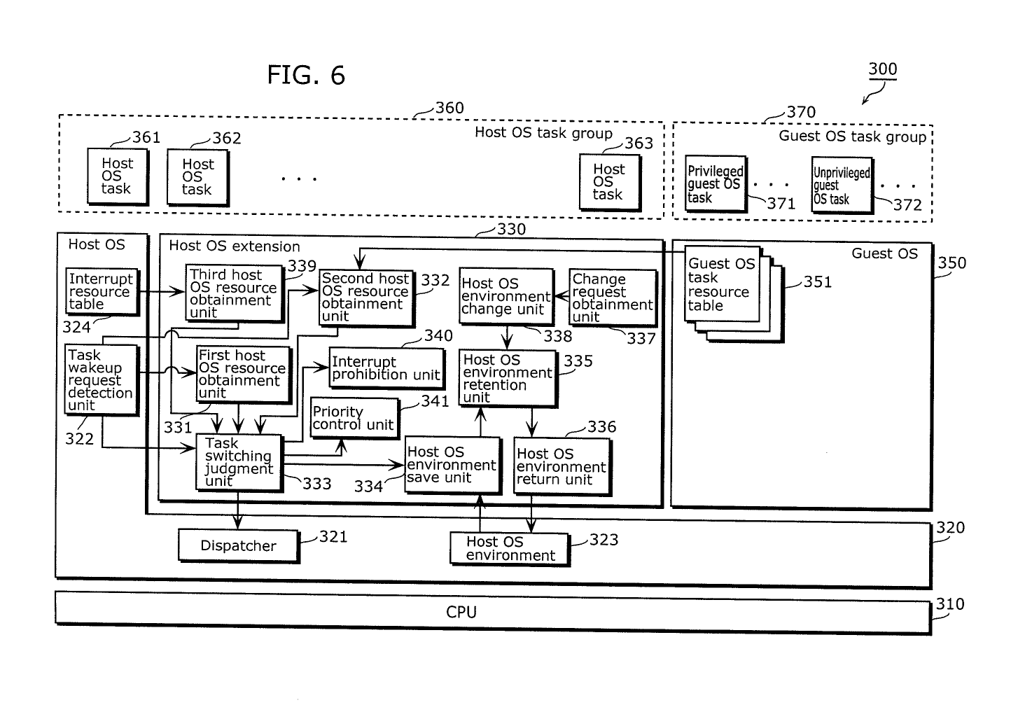

FIG. 6 is a diagram showing the configuration of the computer system according to the third embodiment of the present invention.

A host OS task group 360 and a guest OS task group 370 run in a computer system 300 shown in FIG. 6. The computer system 300 includes a CPU 310 which is a hardware resource, and a host OS 320, a host OS extension 330, and a guest OS 350 which are software resources running on the CPU 310. The host OS is a general-purpose OS, for example. The guest OS 350 runs as at least one task on the host OS 320, and is a real-time OS, for example. The computer system 300 executes the plural tasks included in the host OS task group 360 and the guest OS task group 370 under control of the host OS 320 and the guest OS 350.

The host OS task group 360 includes plural host OS tasks 361, 362, and 363. The host OS tasks 361, 362, and 363 run on the host OS 320. The guest OS task group 370 includes plural privileged guest OS tasks 371 and plural unprivileged guest OS tasks 372. The privileged guest OS task 371 and the unprivileged guest OS task 372 are the tasks on the guest OS 350 which runs as the tasks on the host OS 320. Moreover, the privileged guest OS task 371 is executed in priority to the unprivileged guest OS task 372.

The host OS 320 includes a dispatcher 321, a task wakeup request detection unit 322, a host OS environment 323, and an interrupt resource table 324. The host OS extension 330 includes a first host OS resource obtainment potion 331, a second host OS resource obtainment unit 332, a task switching judgment unit 333, a host OS environment save unit 334, a host OS environment retention unit 335, a host OS environment return unit 336, a change request obtainment unit 337, a host OS environment change unit 338, a third host OS resource obtainment unit 339, an interrupt prohibition unit 340, and a priority control unit 341. The guest OS 350 includes plural guest OS task resource tables 351.

The plural guest OS task resource tables 351 have one-on-one correspondence with the plural privileged guest OS tasks 371. The respective guest OS task resource tables 351 have data of the OS resources which are necessary to execute the corresponding privileged guest OS tasks 371.

The interrupt resource table 324 has data of the OS resources which are necessary to execute an interrupt handler (interrupt process) of the host OS 320.

The task wakeup request detection unit 322 detects wakeup requests of the privileged guest OS task 371.

The first host OS resource obtainment unit 331 obtains the data of the OS resources being used in the computer resources of the host OS 320. The first host OS resource obtainment unit 331 detects the OS resources being used are released when the task switching judgment unit 333 described below judges that the switching to the privileged guest OS task of which the wakeup request is detected is not executable. Furthermore, the first host OS resource obtainment unit 331 obtains the data of the OS resources being used in the computer resources of the host OS 320 when it is detected that the OS resources being used are released.

The second host OS resource obtainment unit 332 obtains the data of the OS resources which are necessary to execute the privileged guest OS task of which the wakeup request is detected with reference to the guest OS task resource table 351 corresponding to the privileged guest OS task of which the wakeup request is detected by the task wakeup request detection unit 322.

The third host OS resource obtainment unit 339 obtains the data of the OS resources which are necessary to execute the interrupt handler of the host OS 320 with reference to the interrupt resource table 324. At this time, the OS resource indicates a memory management structure, a run queue, or the like.

The task switching judgment unit 333 judges whether the task switching to the privileged guest OS task of which the wakeup request is detected is executable or not based on the data of the OS resources being used which are obtained by the first host OS resource obtainment unit 331 and the data of the OS resources obtained by the second host OS resource obtainment unit 332 which are necessary to execute the privileged guest OS task of which the wakeup request is detected. In particular, the task switching judgment unit 333 judges that the task switching to the privileged guest OS task is executable when all the OS resources to be used by the privileged guest OS task of which the wakeup request is detected by the task wakeup request detection unit 322 are not in use.

Furthermore, the task switching judgment unit 333 judges whether the interrupt handler is executable or not during the execution of the privileged guest OS task of which the wakeup request is detected, based on the data of the OS resources being used which are obtained by the first host OS resource obtainment unit 331 and the data of the OS resources obtained by the third host OS resource obtainment unit 339 which are necessary to execute the interrupt handler. In particular, the task switching judgment unit 333 judges that at least part of the OS sources which are necessary to execute the interrupt handler is in use or not based on the data of the OS resources being used which are obtained by the first host OS resource obtainment unit 331 and the data of the OS resources obtained by the third host OS resource obtainment unit 339 which are necessary to execute the interrupt handler. When at least part of the OS resources which are necessary to execute the interrupt handler is in use, the task switching judgment unit 333 judges that the interrupt handler is not executable during the execution of the privileged guest OS task. When all the OS resources which are necessary to execute the interrupt handler are not in use, the task switching judgment unit 333 judges that the interrupt handler is executable during the execution of the privileged guest OS task.

When the task switching judgment unit 333 judges that the task switching is executable, the dispatcher 321 executes the task switching to the privileged guest OS task of which the wakeup request is detected.

The host OS environment 323 is the data of the host OS environment, and for example, it is a priority of the host OS task which is executed before the dispatcher 321 executes the task switching to the privileged guest OS task, a run state of the host OS task being executed (Running or Wait), a scheduling policy, and so on. At this time, the scheduling policy indicates a rule to determine a task execution sequence, for example, a high priority task is executed first, a task is executed in the specified order at specified time intervals, or the like.

When the task switching judgment unit 333 judges that the task switching to the privileged guest OS task of which the wakeup request is detected can be executed and when the dispatcher 321 switches the task to the privileged guest OS task, the host OS environment save unit 334 obtains the host OS environment 323. The host OS environment retention unit 335 retains the host OS environment 323 obtained by the host OS environment save unit 334.

When making the host OS task which is executed before being switched to the privileged guest OS task return after completing the privileged guest OS task, the host OS environment return unit 336 makes the host OS environment which is retained by the host OS environment retention unit 335 return to the host OS 320.

The change request obtainment unit 337 obtains a request to change the state of the host OS task which is executed before being switched to the privileged guest OS task (the priority and the run state) during the execution of the privileged guest OS task. The host OS environment change unit 338 changes the host OS environment retained by the host OS environment retention unit 335 (the state of the host OS task) based on the change request obtained by the change request obtainment unit 337.

The interrupt prohibition unit 340 prohibits the interrupt when the task switching judgment unit 333 judges that the interrupt handler is not executable during the execution of the privileged guest OS task of which the wakeup request is detected.

When the dispatcher 321 switches the task to the privileged guest OS task, the priority control unit 341 makes the priority of the host OS task which is executed before switching the task highest in the priorities of the plural host OS tasks. At this time, the priority indicates the value to determine the execution sequence of the task.

Next, an operation of the computer system 300 is described.

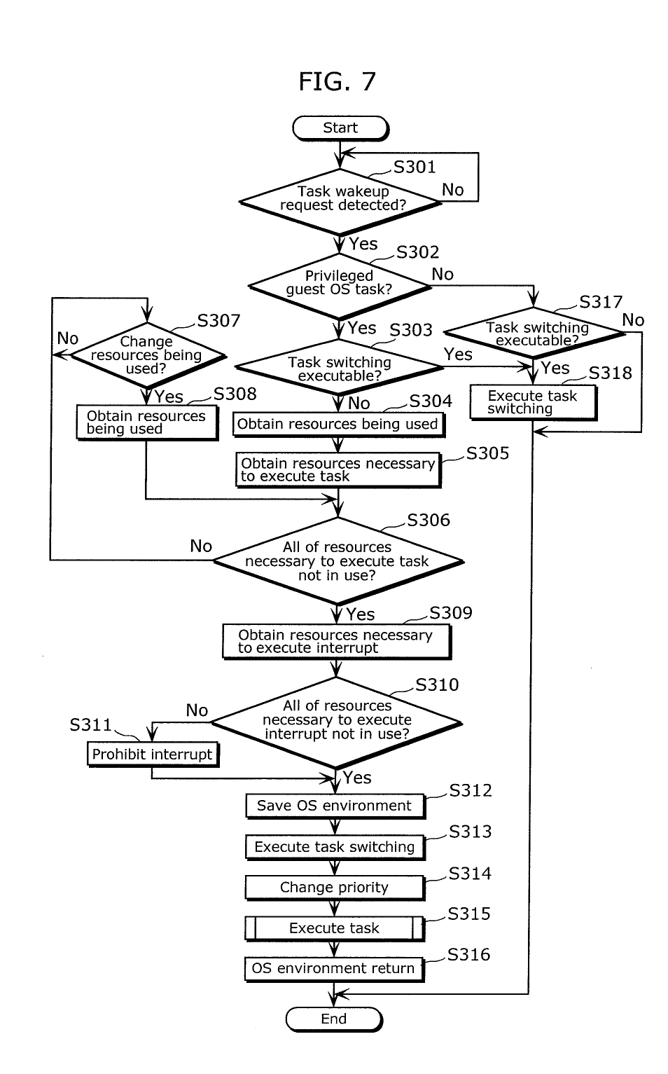

FIG. 7 is a flow chart showing the task switching process in the computer system 300.

As shown in FIG. 7, first, the task wakeup request detection unit 322 detects a wakeup request of the privileged guest OS task (S301). An example when the wakeup request of the privileged guest OS task 371 is detected is described below. At this time, the host OS task 361 is assumed to be executed when the wakeup request of the privileged guest OS task 371 is detected. When the task wakeup request detection unit 322 detects the wakeup request of the privileged guest OS task 371 (Yes in S301), the task wakeup request detection unit 322 judges whether the detected task is the privileged guest OS task or not (S302). The detected task is the privileged guest OS task (Yes in S302), so that the task switching judgment unit 333 next judges that the task switching is executable or not (S303). For example, whether or not the switching on the OS is executable is stipulated depending on the resources being used and, when the switching is executable, the task switching judgment unit 333 judges that the task switching is executable. In particular, the plural resources are specified to stably execute the switching to all the tasks, and when all the specified resources are not in use, it is judged that the task switching is executable. During the execution of the interrupt process, it is judged that the switching is not executable.

When the task switching judgment unit 333 judges that the task switching is not executable (No in S303), the first host OS resource obtainment unit 331 next obtains the data of the OS resources which are currently used by the host OS 320 (S304). Next, the second host OS resource obtainment unit 332 obtains the data of the OS resources which are necessary to execute the privileged guest OS task 371 with reference to the guest OS task resource table 351 corresponding to the privileged guest OS task 371 (S305).

Next, the task switching judgment unit 333 judges whether the task switching to the privileged guest OS task 371 of which the wakeup request is detected is executable or not based on the data of the OS resources being used which are obtained by the first host OS resource obtainment unit 331 and the data of the OS resources obtained by the second host OS resource obtainment unit 332 which are necessary to execute the privileged guest OS task 371 (S306). The task switching judgment unit 333 judges that the task switching to the privileged guest OS task 371 of which the wakeup request is detected is executable when all the OS resources which are necessary to execute the privileged guest OS task 371 of which the wakeup request is detected are not in use (Yes in S306). The task switching judgment unit 333 judges that the task switching is not executable when at least one of the OS resources which are necessary to execute the privileged guest OS task 371 of which the wakeup request is detected is in use (No in S306).

When it is judged that the task switching is not executable in step S306 (No in S306), the first host OS resource obtainment unit 331 monitors whether the OS resources being used are changed or not (S307). When the OS resources being used are changed (Yes in S307), the first host OS resource obtainment unit 331 obtains the data of the OS resources being used after changed (S308). The task switching judgment unit 333 judges whether the task switching to the privileged guest OS task 371 is executable or not based on the data of the OS resources being used which are obtained by the first host OS resource obtainment unit 331 in step S308 and the data of the OS resources obtained by the second host OS resource obtainment unit 332 in step S305 which are necessary to execute the privileged guest OS task 371 (S306). When the task switching is not executable (No in S306), the step S307, S308, and S306 are executed again, and the processes of the step S307, S308, and S306 are repeated until it is judged that the task switching is executable in step S306. That is to say, when it is judged that the task switching to the privileged guest OS task is not executable in step S306 (No in S306), the first host OS resource obtainment unit 331 detects the OS resources being used are released, and when it is detected that the OS resources being used are released, the first host OS resource obtainment unit 331 obtains the data of the OS resources being used again. The task switching judgment unit 333 judges again whether the task switching to the privileged guest OS task 371 is executable or not based on the data of the OS resources being used which are obtained in step S308 and the data of the OS resources obtained by the second host OS resource obtainment unit 332 in step S305 which are necessary to execute the privileged guest OS task 371.

As described above, the computer system according to the third embodiment of the present invention monitors the status of use of the OS resources when the OS resources which are necessary to execute the privileged guest OS task are in use and when the task switching is not executable, and upon the release of the OS resources which are necessary to execute the privileged guest OS task, the task switching is executed. Thus, the task response can be improved when the OS resources which are necessary to execute the privileged guest OS task are in use and when the task switching is not executable.

When it is judged that the task switching is executable in step S306 (Yes in S306), the third host OS resource obtainment unit 339 obtains the data of the OS resources used by the interrupt handler of the host OS with reference to the interrupt resource table 324 (S309). Next, the task switching judgment unit 333 judges whether the interrupt handler is executable or not during the execution of the privileged guest OS task, based on the data of the OS resources which are obtained by the third host OS resource obtainment unit 339 and are used by the interrupt handler and the data of the OS resources being used which are obtained by the first host OS resource obtainment unit 331 (S310). In particular, the task switching judgment unit 333 judges that the interrupt handler is executable when all the OS sources which are necessary to execute the interrupt handler are not in use (Yes in S310). When at least one of the OS resources which are necessary to execute the interrupt handler is in use, the task switching judgment unit 333 judges that the interrupt handler is not executable (No in S310). When the interrupt handler is not executable (No in S310), the interrupt prohibition unit 340 prohibits the interrupt during the execution of the privileged guest OS task 371 (S311). For example, the interrupt prohibition unit 340 prohibits the interrupt during the execution of the privileged guest OS task 371, by raising an interrupt mask level of the host OS.

As described above, when the OS resources which are used for the interrupt handler are in use, the computer system 300 according to the third embodiment of the present invention prohibits the interrupt during the execution of the privileged guest OS task 371. Consequently, the error caused by the interrupt and so on can be prevented in case that the interrupt occurs during the execution the privileged guest OS task 317.

When it is judged that the interrupt handler is executable in step S310 (Yes in S310), the host OS environment save unit 334 obtains the host OS environment 323 of the current host OS 320 and saves the host OS environment 323 in the host OS environment retention unit 335 (S312).

Next, the dispatcher 321 switches the task to the privileged guest OS task 371 of which the wakeup request is detected in step S301 (S313). Next, the priority control unit 341 changes the priority of the host OS task 361 which is executed before switching the task (S314).

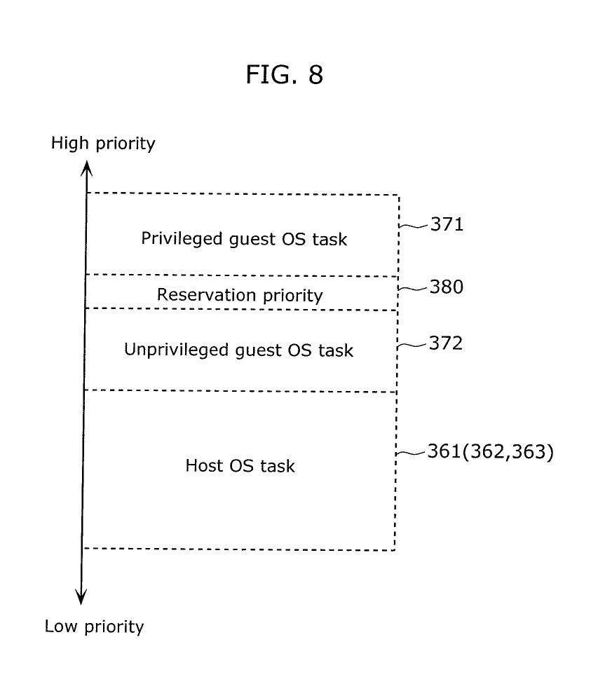

FIG. 8 is a pattern diagram showing a relationship among the task priority of the host OS tasks 361, 362, and 363, the privileged guest OS tasks 371, and the unprivileged guest OS tasks 372.

As shown in FIG. 8, the priority of the plural privileged guest OS tasks 371 is the highest, the priority of the plural unprivileged guest OS tasks 372 is second highest, and the priority of the plural host OS tasks 361, 362, and 363 is the lowest. Moreover, a reservation priority 380 is provided between the priority of the plural privileged guest OS tasks 371 and the priority of the plural unprivileged guest OS task 372.

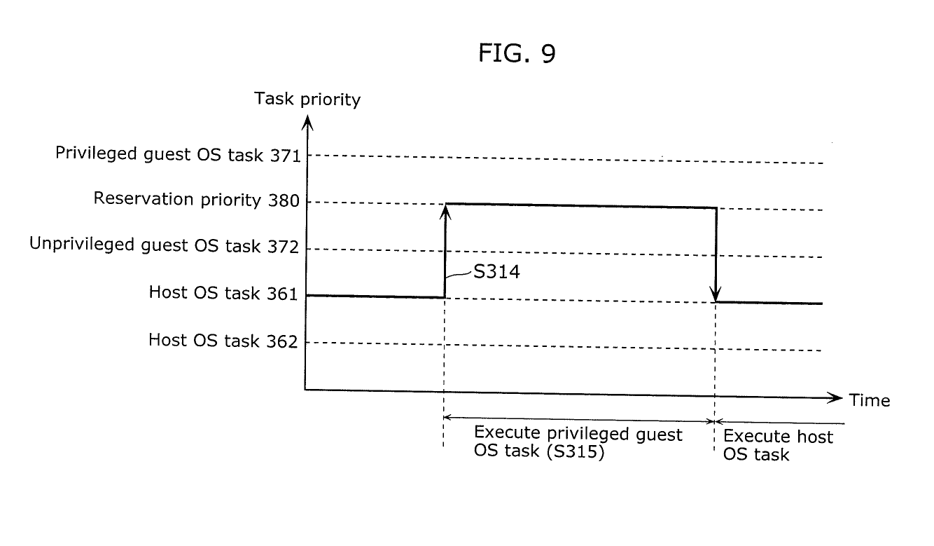

FIG. 9 is a drawing showing an example of changing the priority of the host OS task which is executed before the task switching executed by the priority control unit 341. As shown in FIG. 9, the priority control unit 341 raises the priority of the host OS task 361 to the reservation priority 380 in step S314.

As described above, the computer system 300 according to the third embodiment of the present invention changes the priority of the host OS task 361 (or the unprivileged guest OS task) which is executed before executing the task switching to be highest in the priority of the tasks except for the privileged guest OS task (the host OS task and the unprivileged guest OS task). Consequently, after completing the privileged guest OS task 371, the task is automatically switched to the task which is executed last in the tasks except for the privileged guest OS task (the host OS task and the unprivileged guest OS task). That is to say, the host OS task 361 which is executed before executing the task switching can be automatically executed by changing the priority without improving the function of the existing host OS (improving the scheduler, for example). Moreover, after the host OS environment save unit 334 saves the host OS environment 323 of the host OS 320, the host priority control unit 341 changes the run state of the host OS task 361 which is executed before executing the task switching to be run (Running) when the run state is the waiting (Wait). Consequently, the error that the host OS task 361 is not restarted after completing the privileged guest OS task 371 can be prevented even when the run state of the host OS task 361 is Wait when switching the task to the privileged guest OS task 371.

After the priority is changed by the priority control unit 341 (S314), the privileged guest OS task 371 is executed (S315). After completing the privileged guest OS task 371, the dispatcher 321 switches the task to the host OS task 361 which is executed before executing the task switching. Next, the host OS environment return unit 336 makes the host OS environment which is retained by the host OS environment retention unit 335 return (S316). As described above, in case that the task is switched to the privileged guest OS task 371 during the execution the host OS task 361 and in case that the host OS task is returned after completing the guest OS task, the host OS environment before being switched to the privileged guest OS task 371 is returned. Thus, the consistency of the host OS environment before and after executing the privileged guest OS task 371 can be ensured.

Moreover, as shown in FIG. 9, when the task is switched to the host OS task 361, the priority control unit 341 changes the priority of the host OS task 361 from the reservation priority 380 to the initial priority with reference to the initial priority of the host OS task 361 which is retained by the host OS environment retention unit 335.

In contrast, when it is judged that the task switching is executable in step S303 (Yes in S303), the process of the above S304 to S316 is not executed, and the task is switched to the privileged guest OS task 371 (S318). In this manner, when the host OS 320 is ready for the task switching, the amount of processing of the host OS 320 which is ready for the task switching can be reduced by not executing the process of the S304 to S316.

Next, an example when the wakeup request of the host OS task 363 is detected is described.

When the task wakeup request detection unit 322 detects the wakeup request of the host OS task 363 (Yes in S301), the detected task is the normal task (No in S302), so that the task switching judgment unit 333 next judges whether the task can be switched to the host OS task 363 or not (S317). For example, whether or not the switching on the OS is executable is stipulated depending on the resources being used and, when the switching is executable, the task switching judgment unit 333 judges that the task switching is executable. In particular, the plural resources are specified to stably execute the switching to all the tasks, and when all the specified resources are not in use, it is judged that the task switching is executable. During the execution the interrupt process, it is judged that the switching is not executable.

When the task switching judgment unit 333 judges that the task switching is executable (Yes in S317), the task is switched to the host OS task 363 (S318). Moreover, when the task switching judgment unit 333 judges that the task switching is not executable (No in S317), the task switching is not executed. The process when the wakeup request of the unprivileged guest OS task 372 is detected is similar to the process when the wakeup request of the host OS task 363 is detected.

Next, an operation for changing the state of the host OS task 361 which is executed before being switched to the privileged guest OS task 371 during the step S315 in FIG. 7 is described.

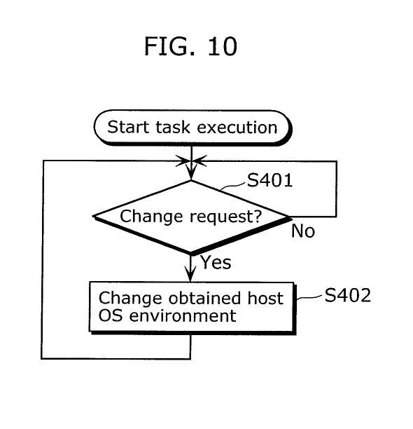

FIG. 10 is a flow chart showing a process to change the state of the host OS task 361 of the computer system 300 during the execution the privileged guest OS task 371. As shown in FIG. 10, the change request obtainment unit 337 monitors the request to change the state of the host OS task 361 which is executed before executing the task switching during the execution the privileged guest OS task 371 to which the task is switched in step S313 (S401). When the change request obtainment unit 337 obtains the change request (Yes in S401), the host OS environment change unit 338 changes the host OS environment retained by the host OS environment retention unit 335 based on the change request obtained by the change request obtainment unit 337 (S402). The changed host OS environment is returned by the host OS environment return unit 336 in the above step S316. At this time, the change request obtained by the change request obtainment unit 337 indicates the run state change request and the priority change request of the host OS task 361 occurred from the privileged guest OS task 371 or the run state change request and the priority change request of the host OS task 361 occurred by the interrupt when the privileged guest OS task 371 runs.

As described above, the computer system 300 according to the third embodiment of the present invention changes the host OS environment which is obtained by the host OS environment retention unit 335 when the change request of the state (the priority, the run state, and so on) to the host OS task 361 which is executed before the task switching occurs. Consequently, the state of the host OS task 361 after returning can be changed, and the consistency of the computer system 300 can be maintained.

In this manner, the computer system 300 according to the third embodiment of the present invention judges whether the task switching to the privileged guest OS task is executable or not based on the data of the OS resources being used and the data of the OS resources which are necessary to execute the privileged guest OS task of which the wakeup request is detected. Thus, when the OS resources which are minimally necessary to execute the privileged guest OS task are not in use, the task switching is executable. Consequently, the task switching is executable in many circumstances compared to the conventional computer system which executes the task switching only when all the resources which enable the computer system to stably execute the switching are not in use. Thus, the computer system 300 according to the third embodiment of the present invention can achieve the computer system which has the high task response performance.

In the above description, when the interrupt handler is not executable in step S310 (No in S310), the interrupt prohibition unit 340 prohibits the interrupt during the execution the privileged guest OS task 371 (S311), however, when the interrupt handler is not executable (No in S310), the task switching judgment unit 333 can judge that the task switching is executable upon the release of the OS resources which are necessary to execute the interrupt handler. A variation of the computer system 300 according to the third embodiment of the present invention, in other words, an operation of a computer system which judges that the task switching can be executed upon the release of the OS resources which are necessary to execute the interrupt handler is described below.

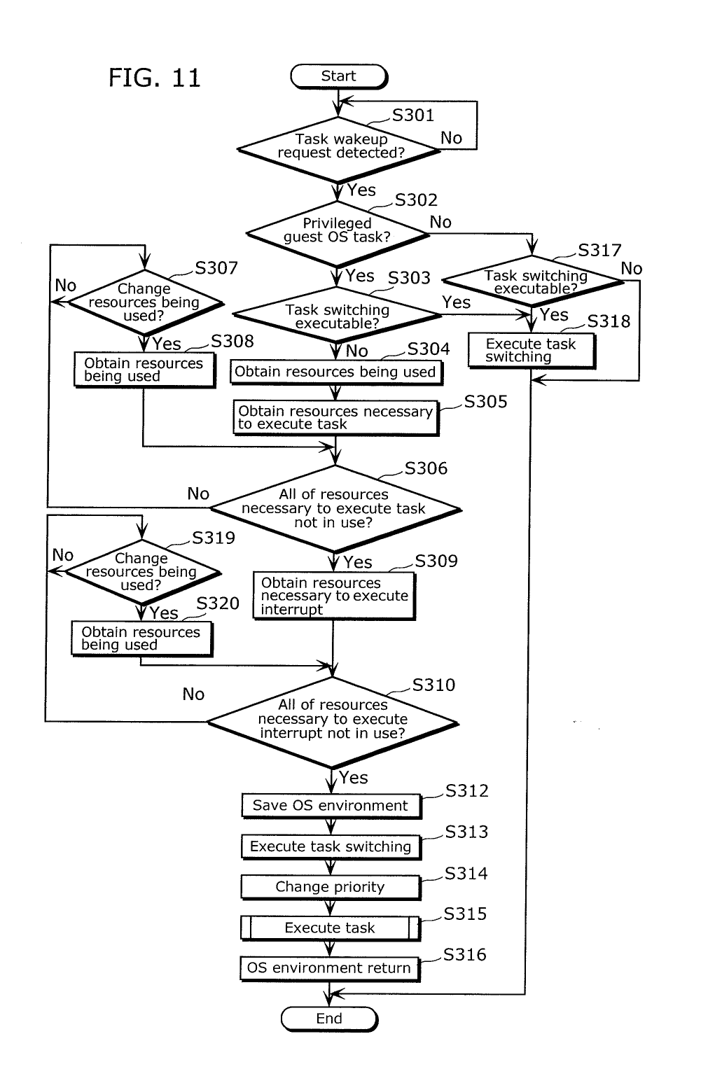

FIG. 11 is a flow chart showing a variation of the task switching process in the computer system 300 according to the third embodiment of the present invention. As shown in FIG. 11, when it is judged that the interrupt handler is not executable (No in S310), the first host OS resource obtainment unit 331 monitors whether the OS resources being used are changed or not (S319). When the OS resources being used are changed (Yes in S319), the first host OS resource obtainment unit 331 obtains the data of the OS resources being used after changed (S320). The task switching judgment unit 333 judges whether the interrupt handler is executable or not during the execution the privileged guest OS task, based on the data of the OS resources being used which are obtained by the first host OS resource obtainment unit 331 in step S320 and the data of the OS resources obtained by the third host OS resource obtainment unit 339 in step S309 which are necessary to execute the interrupt handler (S310). When it is judged that the interrupt handler is not executable (No in S310), the steps S319, S320, and S310 are executed again, and the process of the step S319, S320, and S310 is repeated until it is judged that the interrupt handler is executable in step S310. That is to say, when it is judged that the interrupt handler is not executable in step S310 (No in S310), the first host OS resource obtainment unit 331 detects the OS resources being used are released, and when it is detected that the OS resources being used are released, the first host OS resource obtainment unit 331 obtains the data of the OS resources being used again. The task switching judgment unit 333 judges again whether the interrupt handler is executable or not during the execution the privileged guest OS task 371, based on the data of the OS resources being used which are obtained in step S320 and the data of the OS resources obtained by the third host OS resource obtainment unit 339 in step S309 which are necessary to execute the interrupt handler. The dispatcher 321 switches the task to the privileged guest OS task 371 when it is judged that the task switching can be executed in step S303 and when it is judged that the interrupt handler is executable in step S310.

At this time, as shown in FIG. 7, the task response to the privileged guest OS task can be improved by prohibiting the interrupt, in case that the interrupt handler is not executable during the execution the privileged guest OS task. In contrast, as shown in FIG. 11, the response to the interrupt can be improved by switching the task to the privileged guest OS task upon the release of the OS resources which are necessary to execute the interrupt handler, in case that the interrupt handler is not executable during the execution the privileged guest OS task.

Moreover, in the above description, after completing the privileged guest OS task, the host OS task 361 which is executed before executing the task switching is automatically executed by changing the priority of the host OS task 361 in step S314, however, the following process can also be executed.

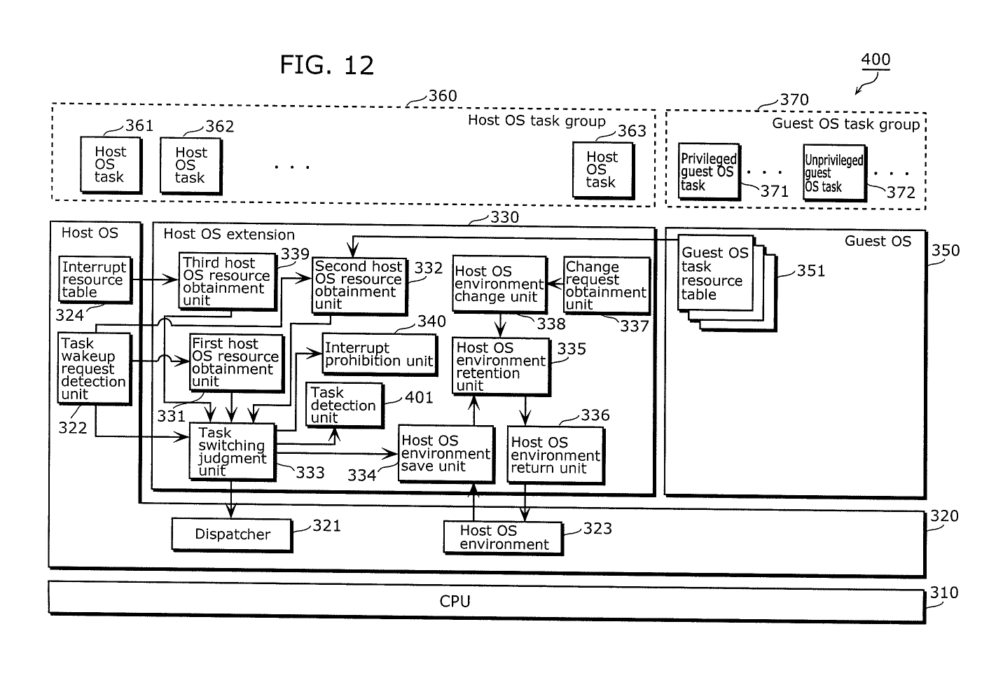

FIG. 12 is a drawing showing a configuration of the variation of the computer system according to the third embodiment of the present invention. A computer system 400 shown in FIG. 12 is different from the computer system 300 shown in FIG. 6 in that the host OS extension 330 has a task detection unit 401 instead of the priority control unit 341. In FIG. 12, codes identical to codes in FIG. 6 are provided to the component similar to that of FIG. 6, and the detailed description is omitted. The task detection unit 401 detects whether there is an executable privileged guest OS task or not when the privileged guest OS task is completed. That is to say, the task detection unit 401 judges whether at least one of the plural privileged guest OS task 371 is in the executable state or not.

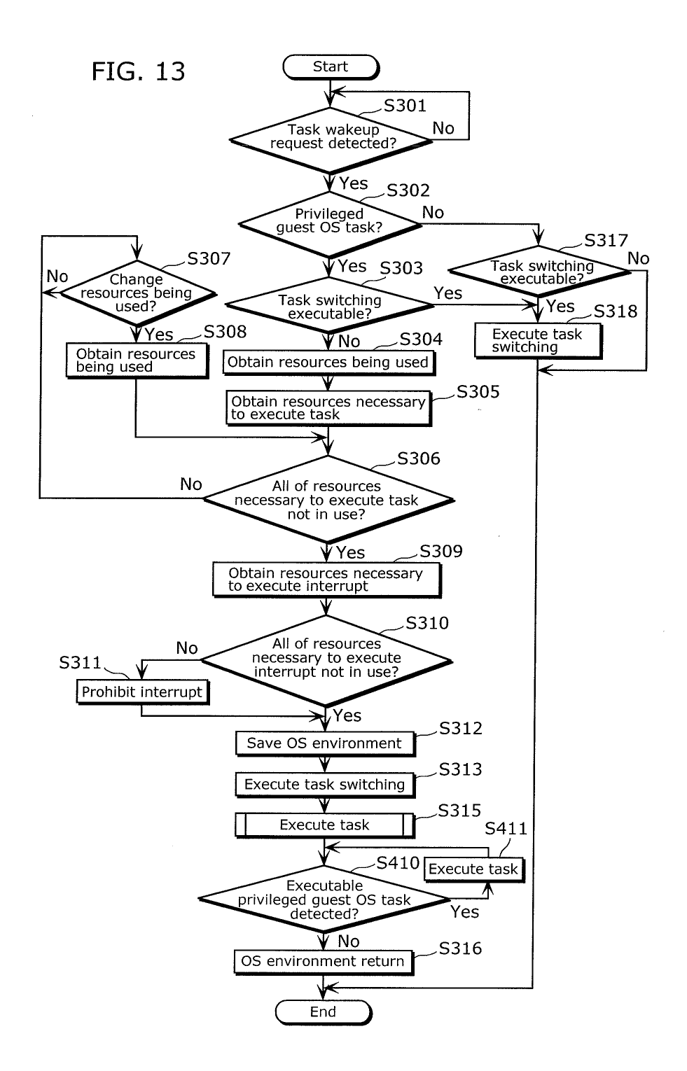

FIG. 13 is a flow chart showing the task switching process in the computer system 400. As shown in FIG. 13, after the task is switched to the privileged guest OS task 371 (S313), the privileged guest OS task is executed (S315) without changing the priority (S314). After the privileged guest OS task is completed (After the step S315), the task detection unit 401 detects whether there is the executable privileged guest OS task or not (S410). When the executable privileged guest OS task is detected (Yes in S410), the dispatcher 321 switches the task to the detected privileged guest OS task, and the detected privileged guest OS task is executed (S411). After the detected privileged guest OS task is completed, the task detection unit 401 detects whether there is the executable privileged guest OS task or not (S410). When the executable privileged guest OS task is not detected (No in S410), the host OS environment return unit 336 makes the host OS environment which is retained by the host OS environment retention unit 335 return (S316). After the host OS environment is returned, the dispatcher 321 forcibly switches the task to the host OS task 361 which is executed before the task switching. According to the above process, the host OS task 361 which is executed before the task switching can be executed after the privileged guest OS task is completed. It is necessary to provide the task detection unit 401 to execute the process shown in FIG. 13. The process through the task detection unit 401 can be executed by improving the scheduler, for example. Thus, the priority change shown in FIG. 7 described above can be executed without improving the scheduler or the like, SO that there is an advantage that the process can be executed easily. In contrast, it is necessary to improve the scheduler or the like for the process shown in FIG. 13, however, there is an advantage that the process can be simplified and thus the task switching can be easily controlled.

Moreover, in the above description, the resources which are necessary to execute the task are obtained (S305) after obtaining the resources being used (S304), however, it is also applicable to obtain the resources being used (S304) after obtaining the resources which are necessary to execute the task (S305). Furthermore, all or part of the process included in step to obtain the resources being used (S304) and all or part of the process included in step to obtain the resources which are necessary to execute the task (S305) may be executed simultaneously.

Moreover, the judgment of the steps S303 and the S317 are executable before the judgment whether the detected task is the privileged guest OS task or not (S302).

Moreover, in the above description, the process of the steps S309 to S311 (the judgment whether the OS resources which are necessary to execute the interrupt handler are in use or not) is executed after executing the process of the steps S305 to S308 (the judgment whether the OS resources which are necessary to execute the privileged guest OS task are in use or not), however, it is also applicable to execute the steps S305 to S308 after executing the process of the steps S309 to S311. Furthermore, all or part of the process included in steps S305 to S308 and all or part of the process included in steps S309 to S311 may be executed simultaneously.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a computer system in which plural tasks run and to a task switching control method in the computer system, and more particularly, to a hybrid OS or the like in which a real-time OS runs as at least one task on a general-purpose OS and to a task switching control method in the hybrid OS.

What is claimed is:

1. A task switching control method in a computer system in which plural tasks run, said method comprising:
a detection step of detecting a wakeup request of a task;
a first resource obtainment step of obtaining first resource data which is data of computer resources being used, among computer resources of the computer system;
a second resource obtainment step of obtaining second resource data which is data of computer resources which are necessary to execute the task of which the wakeup request is detected in said detection step;
a first judgment step of judging whether or not the task can be switched to the task of which the wakeup request is detected in said detection step, based on the first resource data obtained in said first resource obtainment step and the second resource data obtained in said second resource obtainment step; and
a first switching step of switching the task to the task of which the wakeup request is detected in said detection step when it is judged in said first judgment step that the task switching can be executed.

2. The task switching control method according to claim 1,
wherein the computer system executes the plural tasks under control of an OS (Operating System),
the plural tasks include:
a normal task which runs on the OS and uses all of the computer resources of the OS; and
a limited task which runs on the OS and uses only part of the computer resources of the OS,
in said detection step, a wakeup request of the limited task is detected,
in said first resource obtainment step, the first resource data is obtained, the first resource data being the data of the computer resources being used, among the computer resources of the OS,
in said second resource obtainment step, the second resource data is obtained, the second resource data being the data of the computer resources of OS which are necessary to execute the limited task of which the wakeup request is detected in said detection step,
in said first judgment step, it is judged whether or not the task can be switched to the limited task of which the wakeup request is detected in said detection step, based on the first resource data obtained in said first resource obtainment step and the second resource data obtained in said second resource obtainment step, and
in said first switching step, the task is switched to the limited task of which the wakeup request is detected in said detection step when it is judged in said first judgment step that the task switching can be executed.

3. The task switching control method according to claim 1,
wherein the computer system executes the plural tasks under control of a first OS and a second OS which runs as at least one task on the first OS,
the plural tasks include:
a host OS task which runs on the first OS; and
a guest OS task on the second OS, which runs as the task on the first OS and uses the first OS as a host OS,
in said detection step, a wakeup request of the guest OS task is detected,
in said first resource obtainment step, the first resource data is obtained, the first resource data being the data of the computer resources being used, among the computer resources of the first OS,
in said second resource obtainment step, the second resource data is obtained, the second resource data being the data of the computer resources of the first OS which are necessary to execute the guest OS task of which the wakeup request is detected in said detection step,
in said first judgment step, it is judged whether or not the task can be switched to the guest OS task of which the wakeup request is detected in said detection step, based on the first resource data obtained in said first resource obtainment step and the second resource data obtained in said second resource obtainment step, and
in said first switching step, the task is switched to the guest OS task of which the wakeup request is detected in said detection step when it is judged in said first judgment step that the task switching can be executed.

4. The task switching control method according to claim 3,
wherein in said first judgment step, when all of the computer resources to be used by the guest OS task of which the wakeup request is detected in said detection step are not in use, it is judged that the task can be switched to the guest OS task.

5. The task switching control method according to claim 3, further comprising:
a first detection step of detecting that the computer resources of the first OS being used are released when it is judged in said first judgment step that the task cannot be switched to the guest OS task of which the wakeup request is detected;
a first resource reobtainment step of obtaining again the first resource data which is the data of the computer resources of the first OS being used, among the computer resources of the first OS, when it is detected in said first detection step that the computer resources of the first OS being used are released; and
a rejudgment step of judging whether or not the task can be switched to the guest OS task of which the wakeup request is detected in said detection step, based on the first resource data obtained in said first resource reobtainment step and the second resource data obtained in said second resource obtainment step.

6. The task switching control method according to claim 3, further comprising:
a third resource obtainment step of obtaining third resource data which is data of the computer resources of the first OS which are necessary to execute an interrupt process;
a second judgment step of judging whether or not at least part of the computer resources which are necessary to execute the interrupt process are in use, based on the first resource data obtained in said first resource obtainment step and the third resource data obtained in said third resource obtainment step; and
an interrupt prohibition step of prohibiting the interrupt process when it is judged in said second judgment step that at least part of the computer resources which are necessary to execute the interrupt process is in use.

7. The task switching control method according to claim 3, further comprising:
a third resource obtainment step of obtaining third resource data which is data of the computer resources of the first OS which are necessary to execute an interrupt process;
a second judgment step of judging whether or not at least part of the computer resources which are necessary to execute the interrupt process is in use, based on the first resource data obtained in said first resource obtainment step and the third resource data obtained in said third resource obtainment step;
a second detection step of detecting that the computer resources being used are released when it is judged in said second judgment step that at least part of the computer resources which are necessary to execute the interrupt process are in use; and
a second rejudgment step of judging again whether or not at least part of the computer resources of the first OS which are necessary to execute the interrupt process is in use when it is detected in said second detection step that the computer resources of the first OS being used are released, and
in said first switching step, the task is switched to the guest OS task of which the wakeup request is detected in said detection step when it is judged in said first judgment step that the task switching can be executed and it is judged in said second rejudgment step that at least part of the computer resources of the first OS which are necessary to execute the interrupt process is not in use.

8. The task switching control method according to claim 3, further comprising:
an environment retention step of retaining an environment of the first OS when it is judged in said first judgment step that the task can be switched to the guest OS task of which the wakeup request is detected in said detection step; and
an environment return step of causing the environment retained by said environment retention step return when the guest OS task is completed.

9. The task switching control method according to claim 8, further comprising:
a change request obtainment step of obtaining a request to change a state of the host OS task which is executed before switching the task in said first switching step, during execution of the guest OS task that is switched to in said first switching step; and
a task state change step of changing the environment retained in said environment retention step based on the change request obtained in the change request obtainment step,
wherein in said environment return step, the environment which is changed in said task state change step is returned.

10. The task switching control method according to claim 3, further comprising:
a second switching step of switching the task to a host OS task which is executed last among the host OS tasks, after the guest OS task which is switched to in said first switching step is completed.

11. The task switching control method according to claim 3, further comprising:
a task judgment step of judging whether or not at least one of said plural guest OS tasks is executable; and
a second switching step of switching the task to the host OS task which is executed last among the host OS tasks, after the guest OS task is completed when it is judged in said task judgment step that at least one of said plural guest OS tasks is not executable.

12. The task switching control method according to claim 3,
wherein the host OS task and the guest OS task each have a priority for determining a task execution sequence, and
said task switching control method further comprises
a priority change step of changing a priority of the host OS task which is executed before switching the task in said first switching step to a highest priority among said host OS tasks, when it is judged that the task can be switched to the task on said guest OS task.

13. The task switching control method according to claim 3,
wherein the plural tasks include a plurality of the guest OS tasks,
said task switching control method further comprises
a third judgment step of judging whether or not the first OS is ready for switching the task to all of the host OS task and the plurality of guest OS tasks,
in said first switching step, the task is switched to a guest OS task of which the wakeup request is detected in said detection step, when it is judged in said third judgment step that the first OS is ready for the switching, and
in said first judgment step, it is judged whether or not the task can be switched to the guest OS task of which the wakeup request is detected in said detection step, based on the first resource data obtained in said first resource obtainment step and the second resource data obtained in said second resource obtainment step, when it is judged in said third judgment step that the first OS is not ready for the switching.

14. A computer system in which plural tasks run, comprising:
a detection unit operable to detect a wakeup request of a task;
a first resource obtainment unit operable to obtain first resource data which is data of computer resources being used among computer resources of the computer system;
a second resource obtainment unit operable to obtain second resource data which is data of computer resources which are necessary to execute the task of which the wakeup request is detected by said detection unit;
a first judgment unit operable to judge whether or not the task can be switched to the task of which the wakeup request is detected by said detection unit, based on the first resource data obtained by said first resource obtainment unit and the second resource data obtained by said second resource obtainment unit; and
a switching unit operable to switch the task to the task of which the wakeup request is detected by said detection unit when said first judgment unit judges that the task switching is executable.

15. A program which causes a computer to execute a task switching control method in a computer system in which plural tasks run,
wherein the task switching control method includes:
a detection step of detecting a wakeup request of a task;
a first resource obtainment step of obtaining first resource data which is data of computer resources being used among computer resources of the computer system;
a second resource obtainment step of obtaining second resource data which is data of computer resources which are necessary to execute the task of which the wakeup request is detected in said detection step;
a first judgment step of judging whether or not the task can be switched to the task of which the wakeup request is detected in said detection step, based on the first resource data obtained in said first resource obtainment step and the second resource data obtained in said second resource obtainment step; and
a switching step of switching the task to the task of which the wakeup request is detected in said detection step when it is judged in said first judgment step that the task switching can be executed.

16. A recording medium in which a program which causes a computer to execute a task switching control method in a computer system in which plural tasks run is stored,
wherein the task switching control method includes:
a detection step of detecting a wakeup request of a task;
a first resource obtainment step of obtaining first resource data which is data of computer resources being used among computer resources of the computer system;
a second resource obtainment step of obtaining second resource data which is data of computer resources which are necessary to execute the task of which the wakeup request is detected in said detection step;
a first judgment step of judging whether or not the task can be switched to the task of which the wakeup request is detected in said detection step, based on the first resource data obtained in said first resource obtainment step and the second resource data obtained in said second resource obtainment step; and
a switching step of switching the task to the task of which the wakeup request is detected in said detection step when it is judged in said first judgment step that the task switching can be executed.
